(19) United States
(12) Patent Application Publication
(10) Pub. No.: US 2026/0299956 A1
(43) Pub. Date: Oct. 1, 2026

(54) SYSTEMS AND METHODS FOR DYNAMICALLY SWITCHING BETWEEN BRANCH PREDICTION MODES

(71) Applicant: Advanced Micro Devices, Inc., Santa Clara, CA (US)

(72) Inventors: Aparna Chandrashekhar Mandke, Bangalore (IN); Steven R. Havlir, Austin, TX (US); Upamanyu Banerjee, Santa Clara, CA (US)

(73) Assignee: Advanced Micro Devices, Inc., Santa Clara, CA (US)

(21) Appl. No.: 19/096,403

(22) Filed: Mar. 31, 2025

(51) Int. Cl. G06F 9/38; G06F 9/30

(52) U.S. Cl. CPC G06F 9/3806; G06F 9/30058

(57) ABSTRACT

A method for dynamically switching between branch prediction modes may include evaluating a criterion associated with dynamic selection of a mode of speculative prediction of outcomes of one or more branch instructions, wherein the criterion is based on addresses of a plurality of branch instructions executed during a first time period. The method may also include initiating, during a second time period, the mode of speculative prediction of outcomes of the one or more branch instructions, wherein the mode of the speculative prediction is selected based, at least in part, on the criterion.

### BACKGROUND

Processing devices generally execute branch instructions to redirect (or “branch”) the control flow of a computer program to an instruction at an address (e.g., “target address”) indicated by the branch instruction. Types of branch instructions can include unconditional branches that redirect the control flow (or “program flow”) to a predetermined target address, conditional branches that are “taken” to redirect the program flow to a target address if the condition is satisfied or “not taken” to continue sequential execution of instructions if the condition is not satisfied, call instructions that redirect the program flow to an address of a subroutine, return instructions that redirect the program flow from the subroutine to an address after the call instruction that initiated the subroutine, and indirect branch instructions that redirect the program flow to different addresses depending on the state of the processing device or memory.

Many processing devices use branch prediction techniques to predict the outcome of a branch instruction so that the processing device can begin speculatively processing (e.g., fetching, decoding, scheduling, and/or executing) subsequent instructions along the program’s predicted path before the processing device has resolved the branch instruction. In some examples, the processing device predicts the branch’s outcome using information in an entry of a branch prediction structure (e.g., branch target buffer) associated with a block of instructions that includes the branch instruction. If the predicted outcome of the branch turns out to be incorrect (which can be discovered, for example, when the branch instruction is resolved), speculative processing of instructions along the incorrectly predicted path is suspended, the state of the processing device is rolled back to the state at the branch instruction, and the processing device can begin processing instructions along the correct path after the branch. More specifically, both the state of the branch prediction unit (e.g., branch prediction circuit) and the state of the fetch unit (e.g., fetch circuit) can be rolled back to resume processing from the correct target of the branch, or the address after the branch if the branch was not taken.

### BRIEF DESCRIPTION OF THE FIGURES

The accompanying drawings illustrate a number of example implementations and are a part of the specification. Together with the following description, these drawings demonstrate and explain various principles of the present disclosure.

FIG. 1 is a block diagram of an example computer system with one or more processor cores capable of dynamically switching between different modes of branch prediction.

FIG. 2 is a block diagram of a portion of an example processing device that includes a processor core.

FIG. 3 is a block diagram of an example of a first instruction block and a set of second instruction blocks corresponding to different possible outcomes of branch instructions in the first instruction block.

FIG. 4 is a block diagram of an example set of instructions that includes multiple calls to a subroutine.

FIG. 5 is a block diagram of data of a set of a set-associative branch prediction structure.

FIG. 6 is a block diagram of an example branch target buffer.

FIG. 7 is a block diagram of an example multi-mode branch prediction unit.

FIG. 8 is a block diagram of an example multi-mode branch prediction unit configured to dynamically switch between an ahead branch prediction mode and a non-ahead branch prediction mode.

FIG. 9 is a flow diagram of an example method for dynamically switching between different modes of branch prediction.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure describes examples of systems and methods for dynamically switching between (or among) different modes of branch prediction (e.g., an ahead branch prediction mode and a non-ahead branch prediction mode). With “predict ahead” techniques for branch prediction (also referred to herein as “ahead branch prediction” or “ahead-indexed branch prediction”), an address of a first block of instructions is used as an index for accessing information in a branch prediction structure (e.g., a branch target buffer or “BTB”). In some examples, the information includes a set of entries (e.g., BTB entries) corresponding to a set of second instruction blocks. In some examples, each of the second instruction blocks is a potential target of a branch instruction in the first block or the block that follows the first block if none of the branches in the first block are taken. In some examples, the process of the branch predictor predicting the outcome of the branch instructions in the first block (e.g., predicting which of the second blocks of instructions is the next block to be executed after the first block) includes the branch predictor selecting one entry (representing the predicted next block) from the set. In some examples, the predicted next block (the selected second block) includes one or more branch instructions. In some examples, the selected entry for the predicted next block includes branch prediction information for the branch instructions in that block. In some examples, the branch predictor uses the information in the selected entry to predict outcomes of the branch instructions in the second block prior to a determination of whether the outcome of the first block was correctly predicted.

In some examples, the address of the second block is used as an index to information that is used to predict outcomes of branch instructions in a third block at an address predicted as an outcome of the branch instructions in the second block. In some examples, if the branch outcomes or targets of the first block were mispredicted, the processing device is rolled back to the state at the end of the mispredicted branch instruction in the first block, and the processing device resumes execution along the correct path. If the incorrect prediction was that the branch instruction was “not taken” and the actual branch outcome was “taken,” the correct path begins at another one of the set of second blocks that are predicted targets of the branch instructions in the first block. If the incorrect prediction was that the branch instruction was “taken” and the actual branch outcome was “not taken,” the remaining portion of the first block is predicted and fetched before moving on to the second block. When branches are mispredicted and the state of the processing device is rolled back to the mispredicted branch, the performance penalty suffered by the program (e.g., the temporary reduction in the rate at which the device resolves and retires instructions) can be significant.

The effectiveness of predict ahead techniques can depend on the types of branch instructions to which the techniques are applied. The application of predict ahead techniques to conditional and unconditional branch instructions often reduces overall program latency without significantly increasing the rate of branch mispredictions. However, using predict ahead techniques for other types of branch instructions (e.g., indirect branches) can potentially increase the branch misprediction rate, relative to non-ahead branch prediction techniques (e.g., branch predictions techniques in which the address of a block is used as an index to access information that is used to predict outcomes of branch instructions within that same block).

For example, subroutines are often accessed from multiple instruction blocks within a program. With ahead-indexing, a branch prediction structure entry (e.g., BTB entry) representing the block of instructions at the beginning of the subroutine can be generated within each set of entries corresponding to each instruction block that calls the subroutine. Storing multiple entries for the same block consumes space in the branch prediction structure, which can lead to capacity misses. When the branch predictor fails to identify a branch, fails to correctly predict the outcome of the branch, or fails to correctly identify the next block after the branch due to such a capacity miss, a branch misprediction likely occurs.

As another example, if a subroutine is accessed from multiple instruction blocks within a program, the subroutine’s return instruction returns to multiple target addresses in the program. With ahead-indexing, a branch prediction structure (e.g., BTB) can include entries corresponding to each block to which the subroutine returns (each block that contains a target address of the return instruction). In some examples, those entries are indexed by the same source address (i.e., the address of the block containing the return instruction). In some examples, a set-associative branch prediction structure (e.g., BTB) therefore stores those entries in the same set, which creates hotspots in the branch prediction structure and causes conflict misses if the number of ways is less than the number of entries indexed by the same source address. Likewise, indirect branch instructions can generate conflict misses because an indirect branch can jump to different target addresses depending on the state of the processing device or memory, which leads to multiple entries being indexed by the same source address in a manner that is similar to what happens for return instructions.

One option for addressing the disparities in effectiveness of different branch prediction techniques for different types of branch instructions is to simply use different branch prediction techniques for different types of branch instructions. For example, ahead prediction can be used for one subset of branch types (e.g., conditional and unconditional branches), and non-ahead prediction can be used for a second subset of branch types (e.g., calls, returns, and indirect branches). For some workloads, this approach can be very effective. For other workloads, this approach can unduly restrict processor performance by frequently stalling the front end of the processing device’s pipeline (or reducing the rate at which instruction blocks are fetched) when branches of the second type are encountered.

Another option is to use ahead prediction on all types of branches, unless there is evidence that application of ahead prediction to specific branches (or specific types of branches) is causing or likely to cause capacity misses in a branch prediction structure (e.g., BTB). When application of ahead prediction to specific branches (or types of branches) is suspected of causing a high rate of capacity misses, the branch predictor can use non-ahead prediction techniques to predict the outcomes of those branches. In this way, the branch predictor can dynamically switch between ahead prediction and non-ahead prediction for specific branches (or specific types of branches) based on run-time information indicating which type of branch prediction is most likely to provide the best overall performance. Such selective application of ahead prediction can significantly improve the processor’s overall performance for some workloads, including server workloads and other workloads that contain a large number of easy-to-predict conditional branches.

A first scenario in which application of ahead prediction to specific types of branch instructions tends to cause capacity misses in a branch prediction structure occurs when (1) the number of returns (e.g., unique returns) executed in a short time period is high and (2) those returns have a high number of distinct target addresses. (For reasons discussed above, this first scenario can lead to the creation of many duplicate entries in a branch prediction structure for the different blocks containing the return’s distinct target addresses.) In some examples, a branch predictor uses a Bloom filter to detect occurrences of this first scenario. When a return executes, the branch predictor can obtain an index based on the instruction’s address (e.g., a hash of at least some bits of the instruction’s address, a hash of the tag address of the BTB entry corresponding to the block that includes the return instruction, etc.), access the entry in the Bloom filter corresponding to that index, and set the bit of that Bloom filter entry. In addition, the branch predictor can periodically clear (or “reset”) some or all of the bits in the Bloom filter. Thus, the branch predictor can detect the first scenario when the total number of set bits in the Bloom filter exceeds a first threshold value T_{A1}. In this case, the branch predictor can apply non-ahead prediction to all returns until the number of set bits in the Bloom filter no longer exceeds a second threshold value T_{A2} less than or equal to the first threshold value T_{A1}. In some examples, T_{A1} is a multiple of T_{A2} (e.g., T_{A1} = n * T_{A2}, where n is 2, 3, 4, 5, or greater than 5).

A second scenario in which application of ahead prediction to specific branch instructions tends to cause capacity misses in a branch prediction structure occurs when an individual branch instruction (e.g., a return or an indirect branch) in a second block executes with a high number of distinct target addresses in a short period of time, leading to evictions and conflict misses in the set of entries in the branch prediction structure corresponding to a first block that is predicted to precede the second block. In some examples, a branch predictor uses eviction counters for the sets in the branch prediction structure to detect occurrences of this second scenario. When an entry is evicted from an indexed set of entries in the branch prediction structure, the eviction counter for the set can be incremented. In addition, the branch predictor can periodically clear or decrement the eviction counters. Thus, the branch predictor can detect this second scenario when the value of the eviction counter for the indexed set in a branch prediction structure corresponding to the address of a particular instruction block exceeds a first threshold value T_{B1}. In this case, the branch predictor can apply non-ahead prediction to returns and/or indirect branches in that particular instruction block until the value of the eviction counter no longer exceeds a second threshold value T_{B2} less than or equal to the first threshold value T_{B1}. In some examples, T_{B1} is a multiple of T_{B2} (e.g., T_{B1} = m * T_{B2}, where m is 2, 3, 4, 5, or greater than 5).

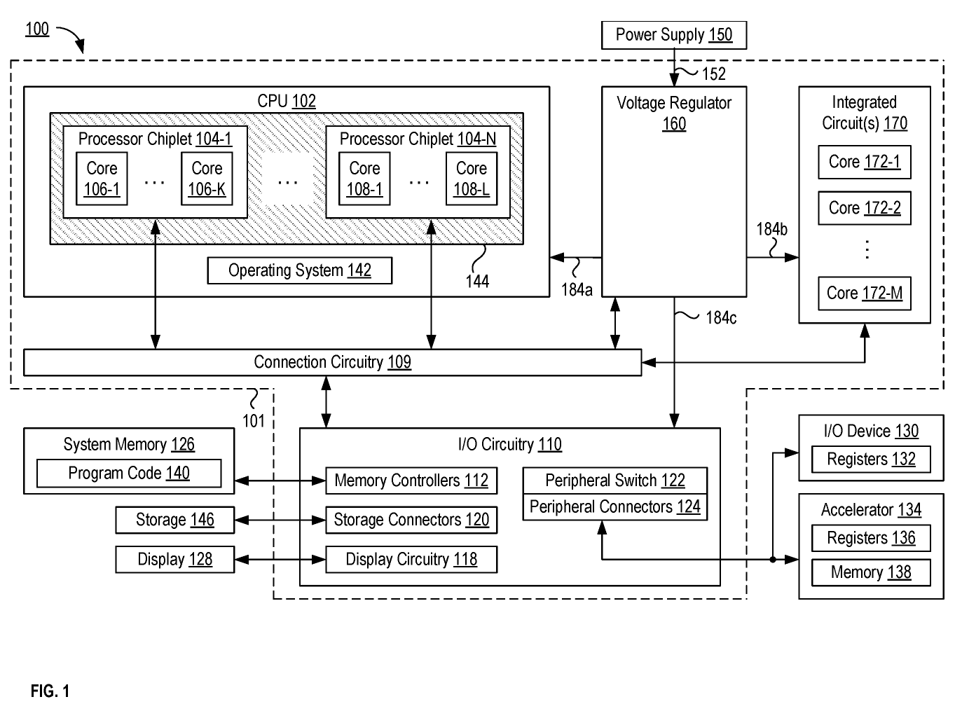

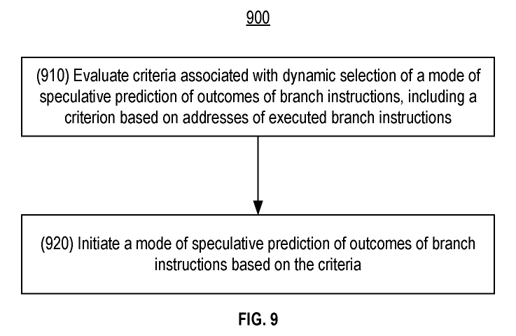

This disclosure provides, with reference to FIGS. 1-8, detailed descriptions of example devices and systems for dynamically switching between (or among) different modes of branch prediction (e.g., ahead branch prediction and non-ahead branch prediction). A detailed descriptions of corresponding methods for dynamically switching between (or among) different modes of branch prediction are provided in connection with FIG. 9.

In some aspects, the techniques described herein relate to a method including: evaluating a criterion associated with dynamic selection of a mode of speculative prediction of outcomes of one or more branch instructions, wherein the criterion is based on addresses of a plurality of branch instructions executed during a first time period; and initiating, during a second time period, the mode of speculative prediction of outcomes of the one or more branch instructions, wherein the mode of the speculative prediction is selected based, at least in part, on the criterion.

In some aspects, the techniques described herein relate to a method, wherein the plurality of branch instructions include a plurality of return instructions.

In some aspects, the techniques described herein relate to a method, wherein the addresses of the plurality of branch instructions include unique instruction addresses of the plurality of return instructions.

In some aspects, the techniques described herein relate to a method, wherein evaluating the criterion includes evaluating the criterion based on addresses of the plurality of branch instructions, and wherein evaluating the criterion includes tracking, by a Bloom filter, the addresses of the plurality of return instructions executed during the first time period.

In some aspects, the techniques described herein relate to a method, wherein evaluating the criterion further includes comparing a number of entries in the Bloom filter having non-zero values to one or more first threshold values.

In some aspects, the techniques described herein relate to a method, further including periodically clearing values of a plurality of entries of the Bloom filter.

In some aspects, the techniques described herein relate to a method, wherein the mode of the speculative prediction is an ahead prediction mode or a non-ahead prediction mode.

In some aspects, the techniques described herein relate to a method, wherein initiating the speculative prediction includes initiating the speculative prediction in an ahead prediction mode, and wherein initiating the speculative prediction in the ahead prediction mode includes: initiating speculative prediction of outcomes of one or more first branch instructions in a first instruction block and outcomes of one or more second branch instructions in a second instruction block concurrently with fetching the first instruction block and the second instruction block.

In some aspects, the techniques described herein relate to a method, wherein the criterion is a first criterion, wherein the method further includes evaluating a second criterion, wherein selection of the mode of the speculative prediction is further based, at least in part, on the second criterion, and wherein the second criterion is based on types of the one or more branch instructions and a value of an eviction counter for a branch target buffer set corresponding to an address of an instruction block that includes the one or more branch instructions.

In some aspects, the techniques described herein relate to a method, wherein evaluating the second criterion includes comparing the value of the eviction counter to one or more second threshold values.

In some aspects, the techniques described herein relate to a method, wherein initiating the speculative prediction includes initiating the speculative prediction in an ahead prediction mode, and wherein initiating the speculative prediction in the ahead prediction mode includes: initiating speculative prediction of outcomes of a plurality of second branch instructions in a set of second blocks that correspond to predicted outcomes of a first branch instruction in a first block; concurrently with the speculative prediction of the outcomes of the plurality of second branch instructions, obtaining data indicating a type of the first branch instruction and a value of an eviction counter for a branch target buffer set corresponding to an address of the first block; and selectively flushing a state associated with the speculative prediction of the outcomes of the plurality of second branch instructions based on the type of the first branch instruction and the value of the eviction counter for the branch target buffer set corresponding to the address of the first block.

In some aspects, the techniques described herein relate to a branch prediction circuit including: a return monitor circuit configured to estimate a number of unique return instructions executed during a first time period; and a branch prediction mode selector circuit configured to evaluate a criterion associated with dynamic selection of a mode of speculative prediction of outcomes of one or more branch instructions, wherein the one or more branch instructions include one or more return instructions, wherein the criterion relates to the number of unique return instructions executed during the first time period, and initiate, during a second time period, a non-ahead mode of speculative prediction of outcomes of the one or more return instructions based, at least in part, on the criterion.

In some aspects, the techniques described herein relate to a branch prediction circuit, wherein the return monitor includes a Bloom filter configured to track addresses of a plurality of return instructions executed during the first time period.

In some aspects, the techniques described herein relate to a branch prediction circuit, wherein the branch prediction mode selector circuit is configured to evaluate the criterion by comparing a number of entries in the Bloom filter having non-zero values to one or more first threshold values.

In some aspects, the techniques described herein relate to a branch prediction circuit, wherein the return monitor is configured to periodically clear values of a plurality of entries of the Bloom filter.

In some aspects, the techniques described herein relate to a branch prediction circuit, further including a branch target buffer (BTB), wherein the criterion is a first criterion, wherein the branch prediction mode selector circuit is further configured to evaluate a second criterion associated with dynamic selection of the mode of speculative prediction, and wherein the second criterion is based on types of the one or more branch instructions and a value of an eviction counter for a set of the BTB corresponding to an address of an instruction block that includes the one or more branch instructions.

In some aspects, the techniques described herein relate to a branch prediction circuit, wherein evaluating the second criterion includes comparing the value of the eviction counter to one or more second threshold values.

In some aspects, the techniques described herein relate to a processor core including: a fetch circuit configured to fetch first and second blocks of instructions during a clock cycle; and a branch prediction circuit configured to selectively perform ahead branch prediction to predict addresses of third and fourth blocks of instructions based on respective addresses of the first and second blocks of instructions, wherein the branch prediction circuit includes: a return monitor configured to estimate a number of unique return instructions executed during a first time period, and a branch prediction mode selector configured to evaluate a criterion associated with dynamic selection of a mode of speculative prediction of outcomes of one or more branch instructions, wherein the one or more branch instructions include one or more return instructions, wherein the criterion relates to the number of unique return instructions executed during the first time period, and initiate, during a second time period, a non-ahead mode of speculative prediction of outcomes of the one or more return instructions based, at least in part, on the criterion.

In some aspects, the techniques described herein relate to a processor core, wherein evaluating the criterion includes tracking, by a Bloom filter, addresses of the one or more return instructions executed during the first time period.

In some aspects, the techniques described herein relate to a processor core, wherein evaluating the criterion further includes comparing a number of entries in the Bloom filter having non-zero values to one or more first threshold values.

FIG. 1 illustrates one exemplary implementation of a computer system 100 (or “processing system”) configured to implement the techniques described herein, although others are possible. It should be appreciated that FIG. 1 is intended neither to be a depiction of necessary components for a computer system 100 to operate in accordance with the principles described herein, nor a comprehensive depiction.

Computer system 100 can be, for example, a desktop computer, a video game console, a server, a wireless access point or other networking element, a mobile computing device (e.g., laptop computers, tablets, smartphones, smartwatches, implantable health monitoring devices, wearable computers, personal digital assistants, etc.), or any other suitable computing system. Computer system 100 can include at least one central processing unit (CPU) 102, one or more integrated circuits 170, connection circuitry 109, I/O circuitry 110, system memory 126, at least one I/O device 130, at least one accelerator 134, storage 146 (e.g., computer-readable storage media), and/or at least one display 128. In some examples, the CPU 102, integrated circuit(s) 170, connection circuitry 109, and I/O circuitry 110, are coupled to (e.g., mounted on) a printed circuit board (e.g., motherboard) 101.

CPU 102 can process data and execute instructions. The data and instructions can be stored on system memory 126, storage 146, and/or internal memory (not shown) of the CPU 102. In some examples, the CPU 102 includes one or more processor chiplets 104-1 … 104-N, which can be disposed on or over a package substrate 144. In some examples, the processor chiplets can communicate with each other via interconnects routed through or on the package substrate 144 (e.g., through an interposer layer disposed between the package substrate 144 and the processor chiplets). In some examples, each processor chiplet includes one or more processor cores (106, 108). Different processor chiplets can have the same or different numbers of cores (106, 108). In the example of FIG. 1, processor chiplet 104-1 has K cores 106-1 … 106-K, and processor chiplet 104-N has L cores (108-1, 108-2, … 108-L). The cores within an individual processor chiplet (e.g., cores 106-1 … 106-K) can be homogeneous or heterogeneous. Likewise, the cores on different processor chiplets (e.g., cores 106-1 and 108-1) can be homogeneous or heterogeneous.

In the example of FIG. 1, the CPU 102 is configured to execute instructions of an operating system 142 and/or instructions (e.g., program code 140) of one or more applications. In some examples, the functionality of the program code can be implemented by one or more integrated circuits 170, one or more CPUs 102, one or more processor chiplets of a CPU 102, and/or one or more cores of a processor chiplet.

The integrated circuit(s) 170 can include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), other processing device, or other integrated circuit. In some examples, an integrated circuit 170 (“IC”) can process data and execute instructions. The data and instructions can be stored in system memory 126, storage 146, and/or internal memory (not shown) of the IC 170. In some examples, the IC 170 includes one or more processor cores 172-1, 172-2, …, 172-M. The cores of the IC 170 can be homogeneous or heterogeneous.

The data and instructions stored on any of the computer-readable storage media (e.g., system memory 126, storage 146, accelerator memory 138, internal or external caches of the CPU 102, etc.) can include computer-executable instructions implementing any suitable functionality.

In some examples, connection circuitry 109 communicatively couples CPUs 102 with each other, with integrated circuit(s) 170, and/or with external caches (e.g., level-2 (L2) cache, level-3 (L3) cache, etc.). Additionally or alternatively, the connection circuitry 109 can communicatively couple the CPUs 102 with I/O circuitry 110, which communicatively couples system memory, storage devices, and peripheral devices to each other and (via the connection circuitry 109) to the CPUs 102. The connection circuitry can couple the CPUs 102, external caches, and I/O circuitry 110 using any suitable network topology (e.g., a front-side bus, a back-side bus, etc.), and the coupled components can send and receive messages via the connection circuitry using any suitable communication protocol. In some examples, portions of the connection circuitry 109 can be integrated into the CPU(s) 102 and/or integrated circuit(s) 170.

In some examples, I/O circuitry 110 includes one or more memory controllers 112, one or more storage connectors 120, display circuitry 118, one or more peripheral connectors 124, and a peripheral switch 122. The memory controller(s) 112 can be configured to control the flow of data to and from the system memory 126. The storage connector(s) 120 can be configured to control the flow of data to and from the storage 146. The display circuitry 118 can be configured to send visual data (e.g., user interface data, image data, video data, etc.) to the display 128, which can be configured to display the visual data. In some examples, the display circuitry 118 can also be configured to receive data representing user input from the display 128 (e.g., in cases where the display 128 includes a touchscreen). In some examples, portions of the I/O circuitry 110 can be integrated into a motherboard and/or motherboard chipset (e.g., I/O circuitry 110) of the computer system 100.

Each of the peripheral connectors 124 can be configured to physically connect and communicatively couple the I/O circuitry 110 to a peripheral device. Any suitable type of peripheral device can be connected to a peripheral connector 124 including, without limitation, an I/O device 130 (e.g., an input device, output device, or input / output device), an accelerator 134, etc. Some non-limiting examples of an input device can include a mouse, keyboard, scanner, video game controller, microphone, webcam, etc. Some non-limiting examples of an output device can include a display, printer, speakers, headphones, earbuds, etc. Some non-limiting examples of an input / output device can include a storage device (e.g., disk drive, solid-state drive, universal serial bus (USB) flash drive, memory card, tape drive, etc.), a networking device (e.g., modem, router, gateway, network adapter, access point, etc.), etc. A networking adapter can be any suitable hardware and/or software to enable the computer system 100 to communicate via wires and/or wirelessly with any other suitable computing system over any suitable computing network. The computing network can include wireless access points, switches, routers, gateways, and/or other networking equipment as well as any suitable wired and/or wireless communication medium or media for exchanging data between two or more computers, including the Internet. Optionally, an I/O device can include one or more registers 132. In some examples, the I/O circuitry 110 can control the operation of an I/O device 130 by writing suitable data to one or more of the I/O device’s registers, and/or can monitor the status of an I/O device 130 by reading the contents of one or more of the I/O device’s registers.

Some non-limiting examples of an accelerator 134 can include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc. In some examples, an accelerator 134 includes one or more registers 136 and memory 138. In some examples, the I/O circuitry 110 can control the operation of an accelerator 134 by writing suitable data to one or more of the accelerator’s registers, and/or can monitor the status of an accelerator 134 by reading the contents of one or more of the accelerator’s registers.

The peripheral switch 122 can be configured to switch packets sent to or from the peripheral devices. Any suitable type of peripheral connector(s) 124 and peripheral switch 122 can be used including, without limitation, universal serial bus (e.g., USB-A, USB-B, USB-C, USB-3.0, etc.), Ethernet, DisplayPort, high-definition multimedia interface (HDMI), peripheral component interconnect (PCI), peripheral component interconnect eXtended (PCI-X), peripheral component interconnect express (PCIe), accelerated graphics port (AGP), etc.

As described above, computer system 100 can have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device can receive input information through speech recognition or in other audible format.

In some examples, computer system 100 further includes a voltage regulator 160. In some examples, the voltage regulator 160 receives power supply signals 152 (e.g., unregulated or insufficiently regulated power supply signals) from a power supply 150, and provides supply signal(s) (e.g., supply signals 184a-c) with regulated voltage(s) to CPU(s) 102, integrated circuit(s) 170, I/O circuitry 110, any other suitable components of the computer system 100, or any subset thereof. In some examples, the power supply 150 is a direct current (DC) power supply, and the signals provided by the power supply 150 are DC power supply signals 152. Some non-limiting examples of power supplies 150 can include one or more batteries (e.g., rechargeable batteries), an alternating current (AC) to DC power adapter (e.g., a power adapter for a mobile computing device), etc.

In some examples, the voltage regulator 160 is configured to provide one or more regulated power supply signals 184 to one or more components of the computer system 100. The voltage regulator 160 can provide each regulated power supply signal with any suitable voltage (e.g., 1 µV to 120 V) and/or any suitable current (e.g., 1 µA – 500 A). In some examples, the voltage regulator 160 is electrically coupled to one or more components of the computer system 100 via the printed circuit board 101 (e.g., motherboard), and the regulated power supply signals are provided to the components of the computer system via traces, wires, or other conductive couplings of the printed circuit board.

In some examples, any of the cores of the computer system 100 (e.g., one or more cores of the CPU 102 and/or one or more cores of the IC 170) can be configured to dynamically switch between (or among) different modes of branch prediction (e.g., dynamically select ahead branch prediction or non-ahead branch prediction for specific branches or types of branches).

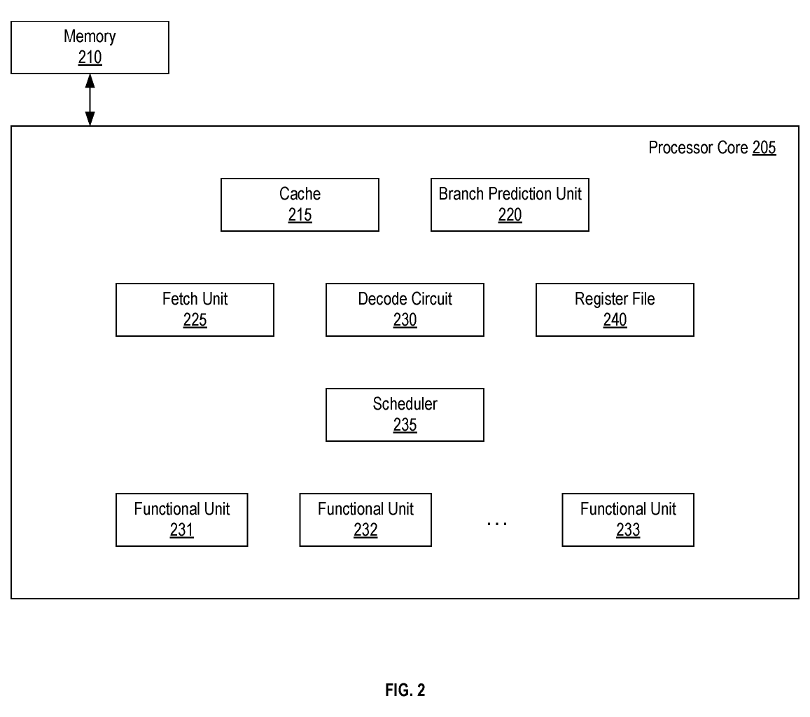

FIG. 2 is a block diagram of a portion of a processing device that includes an example processor core 205. The processor core 205 can be used to implement some examples of the processor cores 106-1 … 106-K, 108-1 … 108-L, and/or 172-1 … 172-M of the computer system 100. The portion 200 of the processing device also includes a memory 210 that can be used, in some examples, to implement the memory 126 of the computer system 100 or on-chip memory of the CPU 102 or IC 170. Copies of some of the information stored in the memory 210 can be stored in a cache 215. For example, frequently accessed instructions can be stored in cache lines or cache blocks of the cache 215.

The processor core 205 includes a branch prediction unit 220 (e.g., branch prediction circuit) configured to dynamically switch between (or among) different modes of branch prediction (e.g., dynamically select ahead branch prediction or non-ahead branch prediction for specific branches or types of branches). The branch prediction unit 220 can include one or more branch prediction structures. In some examples, the branch prediction structures include conditional branch predictor storage and conditional branch prediction logic (e.g., circuitry). The conditional branch predictor storage can stores addresses of locations in the memory 210, and the conditional branch prediction logic can be configured to predict outcomes of branch instructions, as discussed in detail below.

Branch instructions include conditional branch instructions that redirect the program flow to an address dependent upon whether a condition is true or false. For example, conditional branch instructions are used to implement software constructs such as if-then-else statements and case statements. Branch instructions also include unconditional branch instructions that always redirect the program flow to an address indicated by the instruction. For example, a JMP instruction always jumps to an address indicated by the instruction. Branch instructions further include call instructions that redirect the program flow to an entry point of a subroutine and return instructions that redirect the program flow from the subroutine to an instruction following the call instruction in the program flow. For some branches, the target address is provided in a register or memory location so the target address can be different each time the branch is executed. Such branches are called indirect branches.

In some examples, one or more structures of the branch prediction unit 220 include entries associated with branch instructions that have been previously executed by the current process or a process that previously executed on the processor core 205. Branch prediction information stored in entries of such structures of the branch prediction unit 220 can indicate a likelihood that the branch instruction directs the program flow to an address of an instruction (e.g., a target address). The entries in such structures of the branch prediction unit 220 can be accessed based on an address associated with the corresponding branch instruction. For example, the values of the bits (or a subset thereof) that represent a physical address, a virtual address, or a cache line address of the branch instruction can be used as an index into structures of the branch prediction unit 220. For another example, hashed values of the bits (or a subset thereof) can be used as the index into such structures of the branch prediction unit 220. Examples of branch prediction structures include an indirect branch predictor, a return address stack, a branch target buffer, a conditional branch predictor, a branch history, or any other predictor structure that is used to store the branch prediction information.

Some examples of the branch prediction unit 220 include non-ahead branch prediction logic (e.g., circuitry) and ahead branch prediction logic (e.g., circuitry). As used herein, the phrase “non-ahead branch prediction” refers to branch prediction performed by the branch prediction unit 220 for one or more branch instructions in a block based on entries in a branch prediction structure (e.g., a branch target buffer) that are accessed based on an address that identifies the block. As used herein, the phrase “ahead branch prediction” refers to branch prediction performed by the branch prediction unit 220 for one or more branch instructions in a second block based on entries in the branch prediction structure that are accessed based on an address that identifies a block that was previously or is concurrently being processed in the branch prediction unit 220. For example, the branch prediction unit 220 can predict an outcome of a branch instruction in a first block. The outcome can indicate a second block and the ahead branch prediction logic can access entries for branch instructions in the second block based on the address of the first block, as discussed in detail herein.

In some examples, the branch prediction unit 220 dynamically switches between (or among) different modes of branch prediction (e.g., an ahead prediction mode and a non-ahead prediction mode) for a particular branch instruction or branch instructions of a particular type. In some examples, the selection of a branch prediction mode to be applied to a branch instruction B2 is based on the branch instruction’s type and/or on a number of branch target addresses of a plurality of branch instructions B1 of a particular type (e.g., returns) executed during a time period preceding the fetching of the branch instruction B2. For example, the ahead branch prediction logic in the branch prediction unit 220 can be used to perform branch prediction for branch instructions of a first type (e.g., conditional and unconditional branch instructions). In general, the ahead branch prediction logic can also be used to perform branch prediction for branch instructions of a second type (e.g., call instructions that branch to addresses of subroutines, return instructions that return from the subroutine to a subsequent address following the call instruction, and indirect branch instructions). However, in some examples, if the core executes a high number of return instructions to a high number of target addresses in a period preceding the fetching of a branch instruction B2, and B2 is a return, the branch prediction unit can use the non-ahead branch prediction logic to perform branch prediction for B2.

In some examples, the selection of a branch prediction mode to be applied to a branch instruction B1 is based on whether the branch prediction unit 220 has marked B1 for non-ahead prediction. In some examples, the determination that a branch instruction B1 is marked for non-ahead prediction is based on the branch instruction’s type and on a number of recent evictions in the BTB set that stores entries representing potential outcomes (e.g., targets) of B1. For example, a branch instruction B1 can be marked for non-ahead prediction if B1’s type matches a predetermined subset of types (e.g., B1 is a call instruction, return instruction, or indirect branch instruction) and the value of the eviction counter for the BTB set that stores entries representing potential outcomes of B1 exceeds a threshold value. Thus, the ahead branch prediction logic in the branch prediction unit 220 can be used to perform branch prediction for branch instructions B1 of a first type (e.g., conditional and unconditional branch instructions). In general, the ahead branch prediction logic can also be used to perform branch prediction for branch instructions B1 of a second type (e.g., call instructions, return instructions, and indirect branch instructions). However, in some examples, if branch B1 is marked for non-ahead prediction, the branch prediction unit can use non-ahead branch prediction logic to perform branch prediction for B1.

In some examples, the branch prediction unit 220 determines whether a branch B1 is marked for non-ahead prediction (e.g., based on a type of a branch instruction B1 in a first block of instructions and a number of recent evictions from the set of BTB entries representing potential outcomes of B1) concurrently with the fetch unit 225 fetching the first block of instructions. In some examples, the branch prediction unit 220 determines whether a branch B1 is marked for non-ahead prediction concurrently with speculatively predicting outcomes of branch instructions in one or more second blocks that correspond to possible outcomes of the branch instructions in the first block. If the branch prediction unit 220 determines that a type of the branch instruction B1 in the current block is marked for non-ahead prediction, the state of the branch prediction unit 220 is flushed and branch prediction for the block containing branch instruction B1 is reinitiated using the non-ahead branch prediction logic based on the address of that block.

Still referring to FIG. 2, the processor core can include a fetch unit 225, decode unit 230, scheduler 235, register file 240, and functional units 231-233. In some examples, the fetch unit 225 (e.g., fetch circuit) fetches information, such as instructions, from the memory 210 or the cache 215 based on addresses received from the branch prediction unit 220. In some examples, the fetch unit 225 reads the bytes representing the instructions from cache 215 or memory 210 and sends the instructions to the decode unit 230 (e.g., decode circuit). In some examples, the decode unit 230 examines the instruction bytes and determines the function of the instruction. In some examples, the decode unit 230 translates (e.g., decodes) the instruction to generate a set of operations to be performed by the processor core 205. In some examples, these operations are written to the scheduler 235 (e.g., scheduling circuit). In some examples, the scheduler 235 determines when source values for an operation are ready and sends the source values to one or more functional units 231-233 (collectively referred to herein as “the functional units”) to perform the operation. In some examples, the functional units write the operation’s result(s) to a register file 240.

In some examples, the scheduler 235 schedules execution of the instructions by the processor core 205. In some examples, the scheduler 235 schedules speculative execution of instructions following a branch instruction that redirects the program flow to an instruction at a target address in the memory 210 (or cache 215) that is indicated by the branch instruction. The processor core 205 can then speculatively execute the instruction at the target address, as well as subsequent instructions along the predicted path of the program flow. If the branch prediction is incorrect (which can be determined when the branch instruction is resolved), speculative execution along the incorrectly predicted path can be suspended, the state of the processor core 205 can be rolled back to the state at the mispredicted branch instruction, to processing of instructions can result along the correct path.

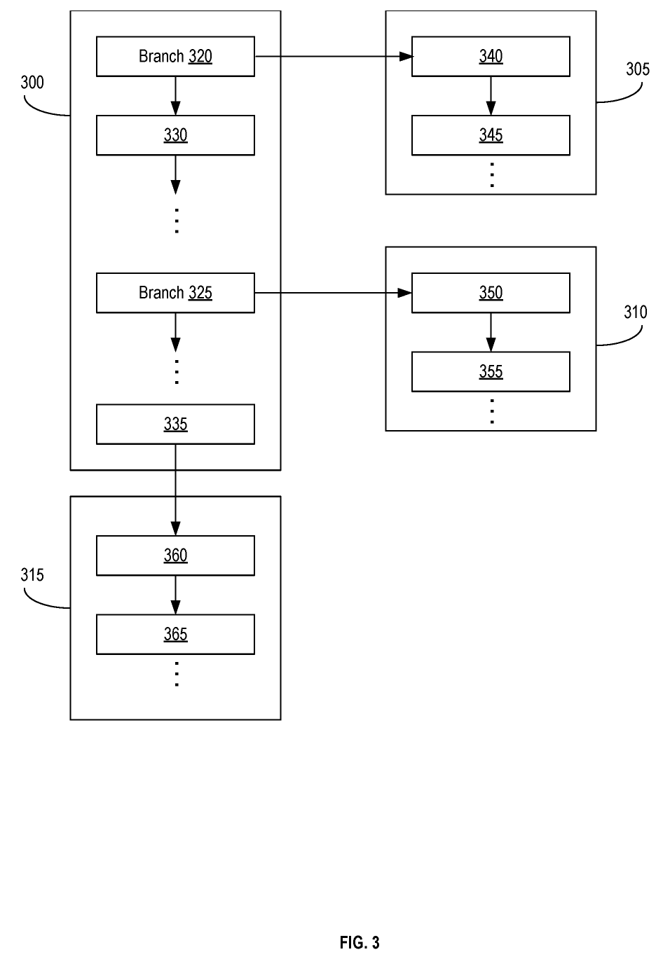

FIG. 3 shows an example of a first instruction block 300 and a set of second instruction blocks (305, 310, 315) corresponding to different possible outcomes of branch instructions in the first instruction block 300. Some non-limiting examples of instruction blocks can include a basic block, the set of instructions stored in a cache line, the set of instructions fetched by the fetch unit in one clock cycle, or any other suitable set of two or more consecutive instructions. In the example of FIG. 3, the first block 300 includes branch instructions 320, 325 and instructions 330, 335. The prediction block 300 can include fewer branch instructions or additional branch instructions (not shown in FIG. 3 in the interest of clarity). The blocks 305, 310, 315 include instructions 340, 345, 350, 355, 360, 365, respectively. The block 305 is identified by a first address that is a target of the branch instruction 320, the block 310 is identified by a second address that is a target of the branch instruction 325, and the block 315 is identified by a third address subsequent to the branch instruction 325. In the illustrated example, the third address is for a subsequent instruction at a boundary such as a cache line boundary between the blocks 300, 315, such as the instruction 360. In other examples, the third address is for a subsequent instruction in the block 300 such as the instruction 335.

In some examples, a branch predictor (e.g., branch prediction unit 220) predicts outcomes of multiple branch instructions within an instruction block (e.g., first instruction block 300). In the illustrated example, the branch predictor concurrently predicts outcomes of the branch instructions 320 and 325. The possible outcomes of the branch instruction 320 are “taken,” in which case the program flow branches to a target address of the instruction 340 in the block 305, or “not taken,” in which case the program flow continues sequentially to the instruction 330 in the block 300. The possible outcomes of the branch instruction 325 are “taken,” in which case the program flow branches to a target address of the instruction 350 in the block 310, or “not taken,” in which case the program flow continues sequentially to the instruction 335 in the block 300.

The instructions 340, 345, 350, 355, 360, 365 in the blocks 305, 310, 315 can include one or more branch instructions. In some examples involving ahead branch prediction, multiple instances of the conditional prediction logic are used to concurrently predict outcomes of the branch instructions in the blocks 305, 310, 315. For example, an address of the block 300 can be used to access information in a conditional branch predictor storage such as prediction information for the blocks 305, 310, 315. The multiple instances of the conditional prediction logic can use the accessed information to predict outcomes of the branch instructions in the blocks 305, 310, 315. As discussed in detail below, speculative execution can proceed along a path including a predicted one of the blocks 305, 310, 315.

In some examples, the branch prediction unit determines types of the branch instructions 320, 325 concurrently with predicting outcomes of the branch instructions in the blocks 305, 310, 315. In some embodiments, an ahead branch predictor is implemented in the branch prediction unit to concurrently predict outcomes of the branch instructions in the blocks 305, 310, 315 using corresponding entries in a branch prediction structure that are accessed based on addresses of the blocks 305, 310, 315, or based on the address of the block 300. In some examples, ahead branch prediction is preferred for all branch instructions except in scenarios in which applying ahead branch prediction to a branch instruction is likely to yield a branch misprediction (e.g., due to capacity misses or conflict misses in a branch prediction structure such as a BTB). Some non-limiting examples of such scenarios are described above. Thus, in some examples, the branch prediction unit dynamically selects ahead or non-ahead branch prediction for branch instructions (e.g., branch instruction 320, 325) based on (1) the branches’ types, (2) an assessment of whether a high number of returns to a high number of distinct target addresses have recently executed, and/or (3) an assessment of whether high number of entries have recently been evicted from the BTB sets storing entries representing potential outcomes (e.g., targets) of the branches (e.g., branches 320, 325).

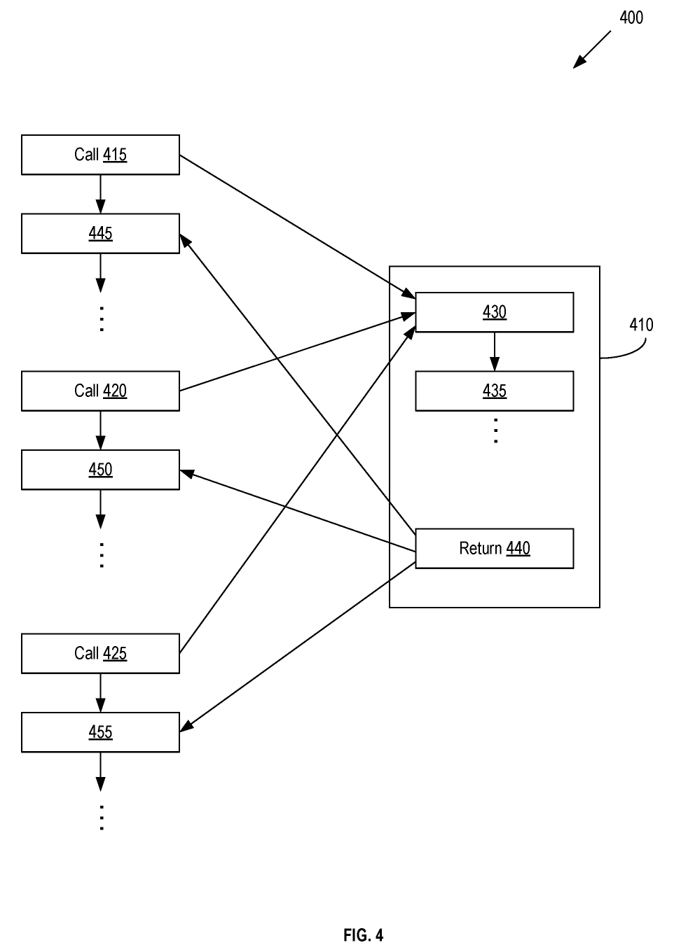

FIG. 4 shows an example set of instructions 400 that includes multiple call instructions (415, 420, 425) to a subroutine 410. In some examples, the call instructions 415, 420, 425 call the subroutine 410 by redirecting the program flow to an entry point of the subroutine (e.g., instruction 430). When ahead branch prediction is used, the branch prediction unit 220 generates an entry E (e.g., BTB entry) for branch instructions in a second block (e.g., branch instructions in the subroutine 410), accesses a set S of entries of a branch prediction structure (e.g., BTB) based on the address of the block that preceded the second block (e.g., the address of the block containing call instruction 415), and stores that entry E in that set S of entries. If all the entries in the set S are already occupied, the branch prediction structure evicts one of the prior entries to provide storage for the new entry E. Any suitable eviction policy can be used to select the entry to be evicted. For example, the evicted entry can be randomly selected from the entries in the set S, the least recently used (LRU) entry can be evicted, the least frequently used (LFU) entry can be evicted, etc. The creation of the entry E, eviction of a prior entry from the set S, and storing of the entry E in the set S can be performed at any suitable time (e.g., when the branch is fetched, decoded, scheduled, executed, or resolved).

Thus, in the example of FIG. 4, the branch prediction unit can generate an entry in the branch prediction structure (e.g., BTB) for the subroutine 410 in sets indexed by the addresses of three blocks containing the three call instructions 415, 420, 425. For example, the branch prediction unit can generate a first entry for the subroutine 410 in a first set of entries of the branch prediction structure indexed by an address of a first block containing the call instruction 415, a second entry for the subroutine 410 in a second set of entries of the branch prediction structure indexed by an address of a second block containing the call instruction 420, and a third entry for the subroutine 410 in a third set of entries of the branch prediction structure indexed by an address of a third block containing the call instruction 425. The branch prediction information in the first, second, and third entries can be the same because these entries correspond to the same subroutine 410.

In the example of FIG. 4, the subroutine 410 includes one or more additional instructions 435 (which can include branch instructions) and a return instruction 440 that redirects the flow back to an instruction subsequent to the call instruction that redirected the program flow to the subroutine 410. For example, the return instruction 440 redirects the flow to the instruction 445 if the subroutine 410 was invoked by the call instruction 415, the instruction 450 if the subroutine 410 was invoked by the call instruction 420, or the instruction 455 if the subroutine 410 was invoked by the call instruction 425. In some examples in which ahead prediction is used, the branch prediction unit generates entries in the branch prediction structure for blocks that are targets of the return instruction 440 (e.g., the blocks containing the instructions 445, 450, and 455). In some examples, these entries are indexed by the same address, e.g., the address of the block containing the return instruction 440. Thus, in a set-associative branch prediction structure, the entries E generated for the three blocks that are targets of the return instruction 440 are stored in the same set S, which creates hotspots in the branch prediction structure and causes conflict misses if the number of ways in the set is less than the number of entries indexed by the same address. As previously noted, the creation of an entry E, eviction of a prior entry from the set S, and storing of the entry E in the set S can be performed at any suitable time (e.g., when the return 440 is fetched, decoded, scheduled, executed, or resolved). If an entry is evicted from the set S to accommodate the storage a new entry E, any suitable eviction policy can be used to select the entry to be evicted.

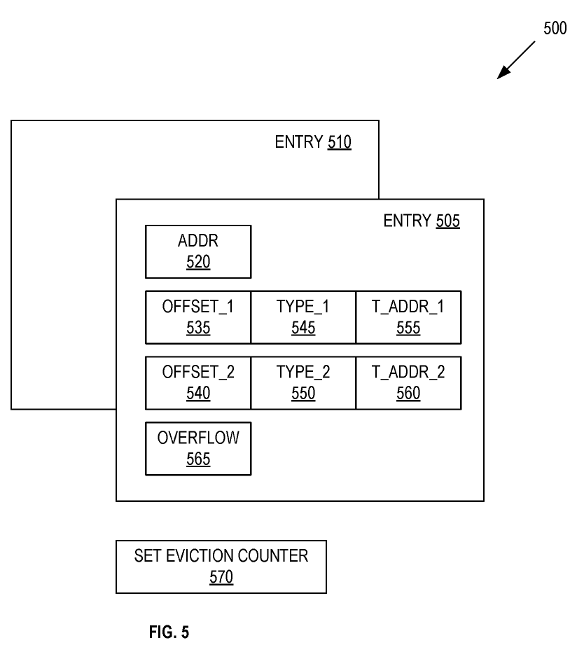

FIG. 5 shows example data of a set 500 of a 2-way set-associative branch prediction structure (e.g., BTB) of a branch prediction unit 220. In the example of FIG. 5, the set data include two entries 505, 510 and the value of an eviction counter 570. In some examples, each entry represents a block of instructions (e.g., a second block that is a potential target of a branch instruction in a first block of instructions). In some examples, the set index is based on the address of the first block of instructions. In some examples, the eviction counter 570 indicates approximately the number of entries evicted from the set during a recent time period.

In some examples, the entries illustrated in FIG. 5 are generated during ahead branch prediction of branch instructions of a process. In the example of FIG. 5, the entry 505 includes branch prediction information for a block of instructions starting at an address 520. The branch prediction information includes information regarding two branch instructions. For example, the entry 505 includes an offset 535 that indicates a location of a first branch instruction relative to the address 520 of the block and an offset 540 that indicates a location of a second branch instruction relative to the address 520 of the block. The entry 505 also includes information identifying types 545, 550 of the first and second branch instructions and the target addresses 555, 560 of the first and second branch instructions. The program flow branches from the first branch instruction to the target address 555 if the first branch instruction is taken. Otherwise, the program flow continues sequentially with instructions in the block until it reaches the second branch instruction. The program flow branches from the second branch instruction to the target address 560 if the second branch instruction is taken, otherwise the program flow continues sequentially with instructions in the block. In some examples, the entry 505 includes an overflow indicator 565 that indicates whether there are additional branch instructions before the end of the block. In some examples, the boundaries of the block match the instruction cache line boundaries. In other examples, the boundaries of the blocks are set at other aligned addresses.

In some examples, the entries illustrated in FIG. 5 are generated during ahead branch prediction of branch instructions such as the return instruction 440 shown in FIG. 4. As described above, the return instruction 440 redirects the program flow to instruction 445, 450, or 455 after the subroutine 410 executes, depending on which of the call instructions (415, 420, 425) invoked the subroutine. In this example, the BTB entries 505, 510 are located in the same set of the BTB because they are indexed by the same address, e.g., the address of the block that includes the return instruction 440 shown in FIG. 4. However, the contents of the entry 505 (e.g., offsets, branch instruction types, target addresses, and overflow values) are different from the contents of entry 510 because the entries 505, 510 are generated for different targets of the return 440 (e.g., the block beginning at instruction 445 and the block beginning at instruction 450).

Thus, if (1) the program flow proceeds sequentially from call instruction 415, through the subroutine 410, through the block starting at instruction 445 to call instruction 420, through the subroutine 410 a second time, through the block starting at instruction 450 to call instruction 425, through the subroutine a third time, and through the block starting at instruction 455; and (2) ahead branch prediction is used for each instance of the return instruction 440; then (3) the branch prediction unit generates a first entry corresponding to the first instance of the return instruction 440 (the instance that returns to instruction 445) and stores the first entry in the set 500, generates a second entry corresponding to the second instance of the return instruction 440 (the instance that returns to instruction 450) and stores the second entry in the set 500, and generates a third entry corresponding to the third instance of the return instruction 440 (the instance that returns to instruction 455). Since the 2-way set 500 is already storing the first and second entries, the BTB evicts one of those entries (e.g., the first entry) and stores the third entry in its place. If the program flow then loops back to call instruction 415, the ahead branch predictor mispredicts the target of the return instruction 440, because the first entry corresponding to the first instance of the return instruction 440 has been evicted from the BTB set. Worse still, if the program flow loops through the illustrated sequence of instructions repeatedly, and ahead branch prediction is used for each instance of the return 440, and the BTB evicts the least-recently used BTB entry from the set 500 each time an instance of the return 440 is executed, the ahead branch predictor mispredicts the target of each instance of the return instruction, despite the targets of the return instruction being easily predictable.

Some examples of the techniques described herein avoid the foregoing scenario by detecting the high number (or rate) of evictions in the BTB set 500 and marking the return instruction 440 for non-ahead prediction. In some examples, each time an entry is evicted from a BTB set 500, the value of the eviction counter for that BTB set is incremented. In some examples, the values of the BTB’s eviction counters are reduced (e.g., decremented, halved, reset to 0, etc.) from time to time (e.g., periodically), such that the eviction count for each BTB set decays over time. In such examples, the value of a BTB set’s eviction counter at a time T provides an estimate of the number or rate of evictions from the BTB set over a time period preceding the time T.

In some examples, when the branch prediction unit 220 initiates ahead prediction for a first instruction block B1 having an address A1, the branch prediction unit accesses the BTB set indexed by the block’s address A1 (e.g., the BTB set containing entries corresponding to second instruction blocks B2 that are potential targets of branch instructions in the first block B1), retrieves the value of that BTB set’s eviction counter, and compares the eviction counter value to a threshold value. In some examples, if the eviction counter value exceeds the threshold value and the block B1 contains a branch instruction of a type within a particular subset of branch types (e.g., returns, calls, and indirect branches), the branch prediction unit marks that branch instruction for non-ahead prediction. In some examples, marking the branch instruction for non-ahead prediction includes flushing the state of any ahead prediction already performed for the branch instruction and reinitiating branch prediction for that branch instruction (or for the block B1) in non-ahead prediction mode. Any suitable threshold value can be used (e.g., 0, 1, 2, or a value greater than 2).

In some examples, using the above-described decay mechanism ensures that branch instructions that have been marked with non-ahead prediction status can subsequently revert to ahead prediction status after the rate of evictions from the corresponding BTB set slows and the value of the BTB set’s eviction counter decays sufficiently. In some examples, the parameters of the decay mechanism (e.g., the time period between decay events, the amount by which the eviction counters are decreased during each decay event, etc.) are selected such that branch instructions do not rapidly toggle between ahead prediction status and non-ahead prediction status. In some examples, the amount of time or number of clock cycles between decay events is approximately 1-5 ms or 500 – 500,000 clock cycles, and the values of the BTB counters are decremented during each decay event.

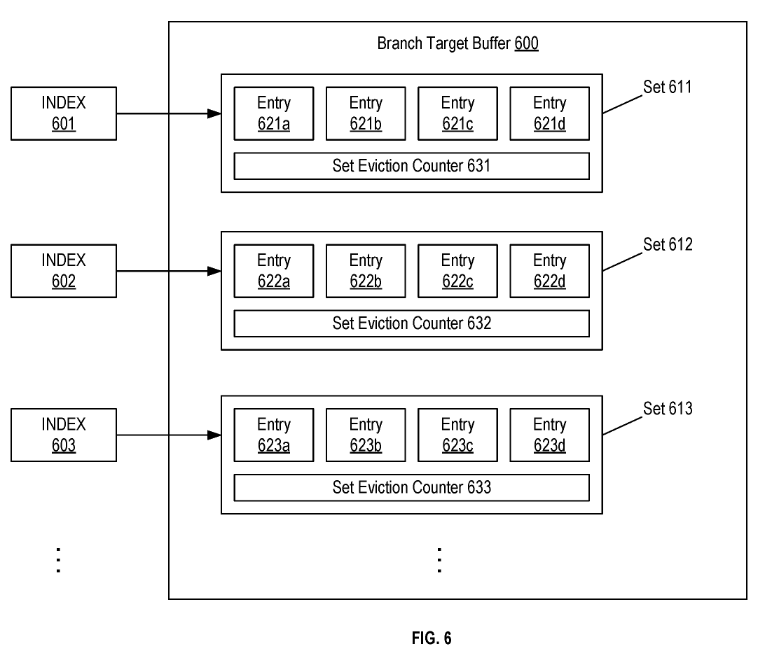

FIG. 6 shows an example branch target buffer (BTB) 600. In some examples, the branch prediction unit 220 includes a branch target buffer. In some examples, the entries of the branch target buffer 600 are indexed using an index that is formed based on an address of an instruction block. For example, when a BTB 600 is used for non-ahead prediction, the address of a block that includes one or more branch instructions can be used to generate the index into the entries of the BTB corresponding to the branch instructions in that block. For another example, when a BTB 600 is used for ahead prediction, an address of a first block can be used to generate the index into the entries of the BTB corresponding to second blocks that are potential outcomes (e.g., targets) of the branch instructions in the first block.

In the example of FIG. 6, the BTB 600 includes a 4-way set-associative buffer that stores entries that include branch prediction information for branch instructions of a process executing on a corresponding processor core. Thus, in the example of FIG. 6, each index is mapped to a set of four entries. For example, the index 601 is mapped to the set 611 (which includes four entries (621a-d) and a set eviction counter 631), the index 602 is mapped to the set 612 (which includes four entries (622a-d) and a set eviction counter 632), and the index 603 is mapped to the set 613 (which includes four entries (623a-d) and a set eviction counter 633). The number of sets in the BTB can be equal to the number of BTB entries divided by the BTB’s associativity (the number of entries in each set). The BTB can have any suitable number of entries (e.g., 1,024, 2,048, 4,096, 8,192, 16,384, etc.) and any suitable associativity (e.g., 2, 3, 4, 6, 8, or more).

In some examples, a branch prediction unit 220 includes two or more BTBs. For example, a branch prediction unit 220 can include a first BTB used for non-ahead branch prediction and a second BTB used for ahead branch prediction. For a non-ahead prediction BTB, the branch prediction unit can generate an index for an instruction block B based on the address of the block B. In addition, the branch prediction unit can generate and store entries in the BTB set corresponding to the index of the block B, and those entries can contain information relating to the branch instructions within the block B. In some examples, a non-ahead BTB can be 1-way or 2-way set associative.

In some examples, for an ahead prediction BTB, the branch prediction unit can generate an index for a first instruction block B1 based on the address of the block B1. In addition, the branch prediction unit can generate and store entries in the BTB set corresponding to the index of the block B1, and those entries can contain information relating to the branch instructions within second blocks B2 that are potential outcomes (e.g., targets) of the branch instructions in the block B1.

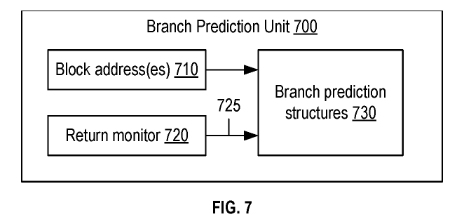

FIGS. 7 shows an example multi-mode branch prediction unit 700. In some examples, the branch prediction unit 220 of a processor core 205 includes (or is) the branch prediction unit 700. In the example of FIG. 7, the multi-mode branch prediction unit 700 includes one or more registers storing addresses 710 of one or more instruction blocks, a return monitor 720, and one or more branch prediction structures 730. In some examples, the branch prediction unit 700 is configured to predict the outcomes of branch instructions contained in the instruction blocks having the addresses 710. In some examples, the branch prediction unit 700 predicts those outcomes in a limited number of clock cycles of a processor core (e.g., a single clock cycle). In some examples, during that limited number of clock cycles, the fetch unit of the processor core fetches the instructions contained in the instruction blocks having the addresses 710.

In some examples, the return monitor 720 includes circuitry that monitors the execution of return instructions. In some examples, the return monitor 720 generates an estimate of the number of return instructions (e.g., unique return instructions) recently executed by the processor core (or by a particular process running on the processor core). In some examples, the return monitor 720 generates an estimate of the number of distinct target addresses used by return instructions recently executed by the processor core (or by a particular process running on the processor core).

In some examples, the return monitor 720 includes a Bloom filter. The Bloom filter can be indexed by index values derived from addresses associated with return instructions (e.g., index values derived from the instruction addresses of return instructions). In some examples, the index is obtained by hashing at least some bits of the address of the return instruction or the tag address of the BTB entry corresponding to the block that includes the return instruction. In some examples, each entry of the Bloom filter is a single bit, and the branch prediction unit 700 sets the bit in the Bloom filter corresponding to the index of a return instruction when the return instruction is resolved. In other examples, each entry of the Bloom filter includes two or more bits, and the branch prediction unit 700 increments the multi-bit value in the Bloom filter entry corresponding to the index of a return instruction when the return instruction is resolved.

In some examples, the return monitor 720 also includes decay circuitry. In some examples, the decay circuitry reduces (e.g., decrements or resets to 0) the values of the Bloom filter’s entries from time to time (e.g., periodically), such that the values of the Bloom filter’s entries decay over time. In such examples, the sum of the values of the Bloom filter’s entries (e.g., the number of set bits in a Bloom filter having single-bit entries) at a time T provides an estimate of the number of return instructions (e.g., the number of unique return instructions) executed by the processor core during a time period preceding the time T. One of ordinary skill in the art will appreciate that the phrase “unique return instructions” can refer to return instructions having unique instruction addresses. In contrast, the phrase “non-unique return instructions” can refer to two or more executed instances of a return instruction having the same instruction address and the same or different target addresses.

The branch prediction unit 700 can include one or more branch prediction structures 730. Some non-limiting examples of branch prediction structures are described herein. In some examples, the branch prediction structures 730 include distinct sets of branch prediction structures that are used in connection with distinct branch prediction modes (e.g., ahead prediction mode or non-ahead prediction mode). Additionally or alternatively, the branch prediction structure 730 can include shared structures that can be selectively configured to operate differently in different branch prediction modes.

In some examples, the branch prediction unit 700 selects the branch prediction mode used for particular branches and/or particular types of branches based, at least in part, on the values of the eviction counters in the BTB sets indexed by the addresses of the instruction blocks containing the branches, as described above in connection with FIG. 5. In some examples, the branch prediction unit 700 selects the branch prediction mode used for particular branches and/or particular types of branches based, at least in part, on the value of a signal 725 generated by the return monitor 720. The signal 725 can indicate the return monitor’s estimate of the number of recently executed return instructions (e.g., unique return instructions). For example, the branch prediction unit 700 can control the operation of the branch prediction structures 730 based, at least in part, on the value of the signal 725. In some examples, the branch prediction unit 700 compares the return monitor’s estimate of the number of return instructions executed during a preceding time period to one or more threshold values and selects the branch prediction mode used for branch instructions based on the results of those comparisons. For example, the branch prediction unit 700 can select a non-ahead prediction mode for branch instructions if the value of the signal 725 exceeds a first threshold value T_{A1} or an ahead prediction mode for branch instructions if the value of the signal 725 is less than a second threshold value T_{A2}.

Thus, in some examples, the branch prediction unit 700 controls the branch prediction structures 730 such that ahead prediction is used for branch instructions if criteria for ahead prediction of returns are met. In some examples, the criteria for ahead prediction of returns include the signal 725 being set to a value indicating a relatively low number of recent returns. In some examples, the criteria for ahead prediction of returns further include the value of the eviction counter of the BTB set indexed by the address of the instruction block containing the return instruction not exceeding another threshold value T_{B2}.

In some examples, the parameters of the return monitor 720 (e.g., the number of entries in the Bloom filter, the time period between decay events, the frequency with which the return monitor calculates the sum of the values of the Bloom filter’s entries, etc.) and the branch prediction unit 700 (e.g., the threshold values T_{A1}, T_{A2}, T_{B1}, and T_{B2}) are selected such that the branch prediction unit 700 does not rapidly toggle between different branch prediction modes for return instructions. In some examples, the number of entries in the Bloom filter is between 1K and 16K (e.g., 1,024, 2,048, 4,096, 8,192, 16,384) or greater than 16K. In some examples, the return monitor calculates the sum of the values of the Bloom filter’s entries during each clock cycle or once every N clock cycles, where N is any suitable number (e.g., a number between 50 and 50,000). In some examples, the first and second threshold values (T_{A1} and T_{A2}) to which the branch prediction unit 700 compares the value of the signal 725 provided by the return monitor 720 are between 32 and 8,192 (e.g., 512 or 1,024) or higher. In some examples, the value of T_{A1} is approximately 4 times the value of T_{A2}. In some examples, the amount of time or number of clock cycles between decay events is approximately 1-5 ms or 500 – 500,000 clock cycles.

An example has been described in which the branch prediction unit 700 uses a Bloom filter to indirectly assess whether capacity misses in the BTB are likely by assessing whether the number of recent returns or recent return addresses is relatively low or relatively high. Alternatively, the branch prediction unit 700 can directly assess whether capacity misses in the BTB are likely by comparing the number of valid BTB entries in the BTB to a threshold value (e.g., a threshold value equal to a specified percentage of the total number of BTB entries, such as 40-70%).

An example has been described in which the return monitor 720 monitors execution of return instructions and estimates the number of recent returns. In some examples, the monitoring circuitry can monitor execution of not only return instructions, but also indirect branches. In such examples, criteria for ahead prediction of returns and/or indirect branches can include the value of the signal 725 being less than a threshold value.

An example has been described in which the branch prediction unit 700 can dynamically switch between an ahead prediction mode and a non-ahead prediction mode for particular branches or types of branches based on various criteria (e.g., the value of a signal 725 and/or the values of eviction counters in BTB sets). Dynamically switching between or among other branch prediction modes is also possible.

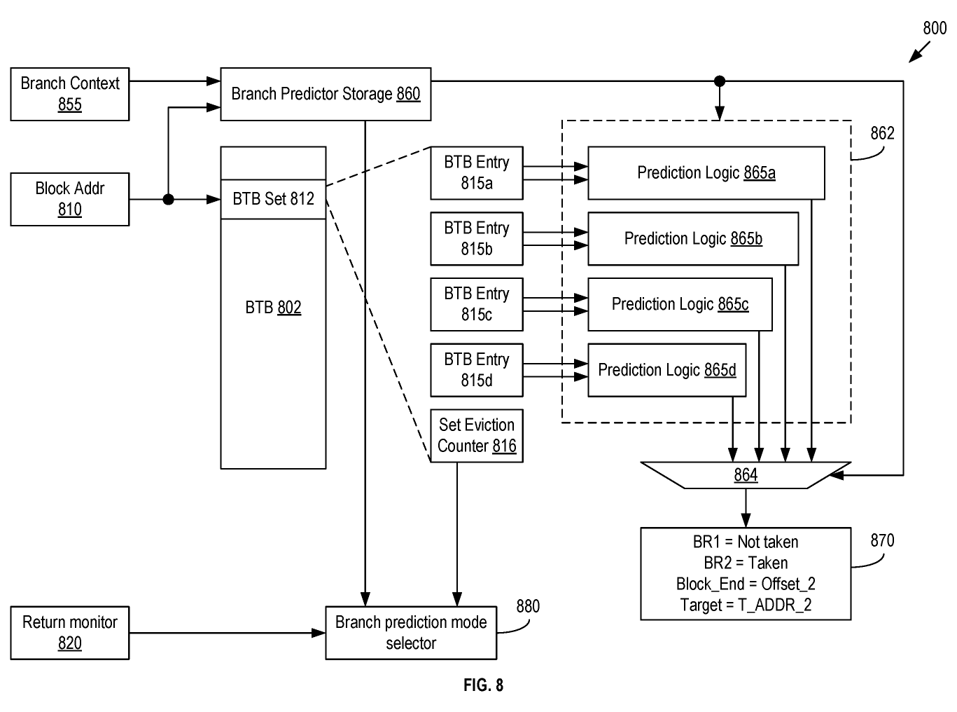

FIG. 8 shows an example of a multi-mode branch prediction unit 800 configured to dynamically switch between speculatively predicting branch outcomes in an ahead branch prediction mode and speculatively predicting branch outcomes in a non-ahead branch prediction mode. In the example of FIG. 8, the branch prediction unit 800 includes a register storing an address 810 of an instruction block, branch context data 855, a branch target buffer (BTB) 802, branch predictor storage 860, branch prediction circuitry 862, an outcome selection circuit 864, a return monitor 820 (e.g., return monitor 720), and a branch prediction mode selector 880. In some examples, the branch prediction unit 800 speculatively predicts the outcomes of one or more branches associated with the instruction block having the indicated block address 810 concurrently with the fetch unit 225 of a processor core 205 fetching the instruction block.

In some examples, the branch context data 855 includes branch history information and/or any other information that can aid the branch prediction unit in correctly predicting the outcomes of one or more branch instructions associated with the instruction block having the indicated address 810. In some examples, the branch context data 855 and the address 810 of the instruction block are provided as input to the branch predictor storage 860. In some examples, the branch predictor storage 860 (e.g., conditional branch predictor storage) stores information that is used to predict outcomes of branch instructions (e.g., branch instructions in the block having address 810). In some examples, the block address 810 (or an index corresponding thereto) is provided to the branch predictor storage 860 to access the stored information associated with the block indicated by the address 810.

In some examples, the accessed information associated with the block having the address 810 is provided to the branch prediction circuitry 862. In some examples, the branch prediction circuitry 862 includes multiple instances of prediction logic 865a-d. In some examples, the number of instances of the prediction logic 865a-d is equal to the set associativity of the BTB 802, such that the branch prediction unit can concurrently process all the BTB entries 815a-d in a BTB set 812.

In some examples, the address 810 of a first block (or an index derived therefrom) is used to identify a corresponding BTB set 812 in the BTB 802. In some examples, the BTB 802 is an ahead prediction BTB, such that the BTB set 812 indexed by the address 810 of a first block stores BTB entries relating to second blocks that are potential outcomes (e.g., targets) of the branch instructions in the first block. In some examples, the branch prediction unit 800 uses the instances of the prediction logic 865a-d to predict the outcomes of the branches in the BTB entries 815a-d representing the second blocks.

In some examples, the branch prediction unit 800 includes a selection circuit 864 that selects one of the second blocks represented by the BTB entries 815a-d as the predicted outcome (e.g., target) of the branch instructions in the first block based on the information retrieved from the branch predictor storage 860. In some examples, the outcomes of the branches in the selected second block are predicted by the prediction logic, as described above. In some examples, the predicted outcomes of the branches in the selected second block constitute the ahead prediction 870 for the block at address 810. In the example of FIG. 8, the ahead prediction 870 includes the prediction that a first branch of the predicted second block is not taken, the prediction that a second branch of the predicted second block is taken (meaning that execution of the second block ends with the second branch instruction, which has an address that offset from the beginning of the second block by the amount “Offset_2”), and the prediction that the target of the second branch instruction is address “T_ADDR_2.”

In some examples, concurrently with carrying out the ahead prediction for the block B having the address 810, the branch prediction unit (e.g., the branch prediction mode selector 880 of the branch prediction unit 800) evaluates one or more criteria relating to a preferred mode of branch prediction for the block B. In some examples, the evaluation of the criteria can depend on the value of the signal provided by the return monitor 820, the information retrieved from the branch predictor storage 860 (e.g., the types of the branches in the block B), and/or the value of the set eviction counter 816 for the BTB set 812 that stores the BTB entries 815a-d corresponding to second blocks that are potential outcomes (e.g., targets) of the branch instructions in the block B. Some non-limiting examples of such criteria are described herein. In some examples, if evaluation of the criteria indicates that the preferred mode of branch prediction for the block B is non-ahead mode, the branch prediction unit 800 flushes the state associated with ahead branch prediction already performed for the block B and initiates branch prediction for the block B in non-ahead mode. For example, the branch prediction unit 800 can flush the ahead prediction state and initiate non-ahead prediction for the block B if the information retrieved from the branch predictor storage 860 indicates that the block B includes a return instruction (or the information retrieved from the BTB 802 indicates that the selected second block includes a return instruction) and the number of recently-executed return instructions (as indicated by the signal provided by the return monitor 820) is greater than a threshold value T_{A1}. As another example, the branch prediction unit 800 can flush the ahead prediction state and initiate non-ahead prediction for the block B if the information retrieved from the branch predictor storage 860 indicates that the block B includes a call, return, or indirect branch instruction and the set eviction counter 816 for the BTB set 812 indexed by the address of the block B indicates that the number of recent evictions from the BTB set 812 exceeds a threshold value T_{B1}.

In the example of FIG. 8, the branch prediction unit 800 can perform ahead branch prediction, specifically 1-ahead branch prediction. In other examples, the branch prediction unit 800 can perform N-ahead branch prediction, where N is 1, 2, 3, or greater. In some examples, if the fetch unit 225 is capable of fetching M blocks simultaneously, branch prediction unit 800 can generate ahead predictions for each of those M blocks simultaneously. In such examples, the number of block addresses provided to the branch prediction unit 800 at the beginning of a clock cycle is M, and the branch prediction unit can generate ahead predictions for each of those M blocks concurrently with the fetch unit fetching the M blocks. In some examples, the BTB 802 is replicated M times or equipped with M ports, the branch predictor storage 860 is replicated M times or equipped with M ports, the branch prediction circuitry 862 is replicated M times, and the mode selection criteria are evaluated M times (once for each of the M blocks).

FIG. 9 shows an example method 900 for dynamically switching between different modes of branch prediction. The method includes step 910 and 920. In step 910, a branch prediction unit evaluates one or more criteria associated with dynamic selection of a mode of speculative prediction of outcomes of branch instructions. Some non-limiting examples of suitable criteria and techniques for evaluating such criteria are described herein. In some examples, the criteria include a criterion that is based on addresses of recently-executed branch instructions. Some non-limiting examples of such a criterion are described herein.

In step 920, the branch prediction unit selects and initiates a mode of speculative prediction of outcomes of branch instructions based on the criteria. In some examples, the selected mode is an ahead prediction mode or a non-ahead prediction mode. In some examples, the selected mode is selected for branches of a particular type (e.g., returns, calls, or indirect branches). Some non-limiting examples of techniques for dynamically switching between modes of speculative prediction are described herein.

Techniques operating according to the principles described herein can be implemented in any suitable manner. While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered as non-limiting examples since many other architectures can be implemented to achieve the same functionality.

Included in the discussion above are flowcharts showing steps and acts of processes determine the value of a reliability metric and/or control the operating point of a component of a computer system. The processing and decision blocks of the flowcharts above represent steps and acts that can be included in algorithms that carry out these processes. Algorithms derived from these processes (or steps thereof) can be implemented as software integrated with and directing the operation of one or more single- or multi-purpose processors (e.g., central processing units (CPUs), graphics processing units (GPUs), tensor processing units (TPUs), hardware accelerators, etc.), can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flowchart(s) included herein do not depict the syntax or operation of any particular circuit or of any particular programming language or type of programming language. Rather, the flowchart(s) illustrate the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flowchart is merely illustrative of the algorithms that can be implemented and can be varied in implementations and embodiments of the principles described herein.

Accordingly, in some embodiments, the techniques described herein can be embodied in computer-executable instructions implemented as software, including as application software, system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative embodiments, be adapted to interact with other, unrelated functional facilities and/or processes, to implement a software program application. In other implementations, the functional facilities can be adapted to interact with other functional facilities in such a way as form an operating system, including the Windows^{®} operating system, available from the Microsoft^{®} Corporation of Redmond, Washington. In other words, in some implementations, the functional facilities can be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that can implement the exemplary techniques described herein, and that embodiments are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

Computer-executable instructions implementing the techniques described herein (when implemented as one or more functional facilities or in any other manner) can, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as system memory 126, accelerator memory 138, storage 146 of the computer system 100 of FIG. 1, or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

Further, some techniques described above comprise acts of storing information (e.g., data and/or instructions) in certain ways for use by these techniques. In some implementations of these techniques - such as implementations where the techniques are implemented as computer-executable instructions - the information can be encoded on a computer-readable storage media. Where specific structures are described herein as advantageous formats in which to store this information, these structures can be used to impart a physical organization of the information when encoded on the storage medium. These advantageous structures can then provide functionality to the storage medium by affecting operations of one or more processors interacting with the information; for example, by increasing the efficiency of computer operations performed by the processor(s).

In some, but not all, implementations in which the techniques can be embodied as computer-executable instructions, these instructions can be executed on one or more suitable computing device(s) operating in any suitable computer system, or one or more computing devices (or one or more processors of one or more computing devices) can be programmed to execute the computer-executable instructions. A computing device or processor can be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

Embodiments have been described where the techniques are implemented in circuitry and/or computer-executable instructions. It should be appreciated that some embodiments can be in the form of a method, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments.

Various aspects of the embodiments described above can be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment can be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Unless otherwise noted, the terms “connected to” and “coupled to” (and their derivatives), as used in the specification and claims, are to be construed as permitting both direct and indirect (i.e., via other elements or components) connection.

Unless otherwise noted, a first numeric value is “approximately” equal to a second numeric value if the first numeric value is within + 20%, + 10%, or + 5% of the second numeric value.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A method comprising:
evaluating a criterion associated with dynamic selection of a mode of speculative prediction of outcomes of one or more branch instructions, wherein the criterion is based on addresses of a plurality of branch instructions executed during a first time period; and
initiating, during a second time period, the mode of speculative prediction of outcomes of the one or more branch instructions, wherein the mode of the speculative prediction is selected based, at least in part, on the criterion.

2. The method of claim 1, wherein the plurality of branch instructions include a plurality of return instructions.

3. The method of claim 2, wherein the addresses of the plurality of branch instructions include unique instruction addresses of the plurality of return instructions.

4. The method of claim 2, wherein evaluating the criterion includes evaluating the criterion based on addresses of the plurality of branch instructions, and wherein evaluating the criterion includes tracking, by a Bloom filter, the addresses of the plurality of return instructions executed during the first time period.

5. The method of claim 4, wherein evaluating the criterion further includes comparing a number of entries in the Bloom filter having non-zero values to one or more first threshold values.

6. The method of claim 4, further including periodically clearing values of a plurality of entries of the Bloom filter.

7. The method of claim 1, wherein the mode of the speculative prediction is an ahead prediction mode or a non-ahead prediction mode.

8. The method of claim 1, wherein initiating the speculative prediction includes initiating the speculative prediction in an ahead prediction mode, and wherein initiating the speculative prediction in the ahead prediction mode includes:
initiating speculative prediction of outcomes of one or more first branch instructions in a first instruction block and outcomes of one or more second branch instructions in a second instruction block concurrently with fetching the first instruction block and the second instruction block.

9. The method of claim 1, wherein the criterion is a first criterion, wherein the method further includes evaluating a second criterion, wherein selection of the mode of the speculative prediction is further based, at least in part, on the second criterion, and wherein the second criterion is based on types of the one or more branch instructions and a value of an eviction counter for a branch target buffer set corresponding to an address of an instruction block that includes the one or more branch instructions.

10. The method of claim 9, wherein evaluating the second criterion includes comparing the value of the eviction counter to one or more second threshold values.

11. The method of claim 1, wherein initiating the speculative prediction includes initiating the speculative prediction in an ahead prediction mode, and wherein initiating the speculative prediction in the ahead prediction mode includes:
initiating speculative prediction of outcomes of a plurality of second branch instructions in a set of second blocks that correspond to predicted outcomes of a first branch instruction in a first block;
concurrently with the speculative prediction of the outcomes of the plurality of second branch instructions, obtaining data indicating a type of the first branch instruction and a value of an eviction counter for a branch target buffer set corresponding to an address of the first block; and
selectively flushing a state associated with the speculative prediction of the outcomes of the plurality of second branch instructions based on the type of the first branch instruction and the value of the eviction counter for the branch target buffer set corresponding to the address of the first block.

12. A branch prediction circuit comprising:
a return monitor circuit configured to estimate a number of unique return instructions executed during a first time period; and
a branch prediction mode selector circuit configured to
evaluate a criterion associated with dynamic selection of a mode of speculative prediction of outcomes of one or more branch instructions, wherein the one or more branch instructions include one or more return instructions, wherein the criterion relates to the number of unique return instructions executed during the first time period, and
initiate, during a second time period, a non-ahead mode of speculative prediction of outcomes of the one or more return instructions based, at least in part, on the criterion.

13. The branch prediction circuit of claim 12, wherein the return monitor includes a Bloom filter configured to track addresses of a plurality of return instructions executed during the first time period.

14. The branch prediction circuit of claim 13, wherein the branch prediction mode selector circuit is configured to evaluate the criterion by comparing a number of entries in the Bloom filter having non-zero values to one or more first threshold values.

15. The branch prediction circuit of claim 13, wherein the return monitor is configured to periodically clear values of a plurality of entries of the Bloom filter.

16. The branch prediction circuit of claim 12, further comprising a branch target buffer (BTB), wherein the criterion is a first criterion, wherein the branch prediction mode selector circuit is further configured to evaluate a second criterion associated with dynamic selection of the mode of speculative prediction, and wherein the second criterion is based on types of the one or more branch instructions and a value of an eviction counter for a set of the BTB corresponding to an address of an instruction block that includes the one or more branch instructions.

17. The branch prediction circuit of claim 16, wherein evaluating the second criterion includes comparing the value of the eviction counter to one or more second threshold values.

18. A processor core comprising:
a fetch circuit configured to fetch first and second blocks of instructions during a clock cycle; and
a branch prediction circuit configured to selectively perform ahead branch prediction to predict addresses of third and fourth blocks of instructions based on respective addresses of the first and second blocks of instructions, wherein the branch prediction circuit includes:
a return monitor configured to estimate a number of unique return instructions executed during a first time period, and
a branch prediction mode selector configured to
evaluate a criterion associated with dynamic selection of a mode of speculative prediction of outcomes of one or more branch instructions, wherein the one or more branch instructions include one or more return instructions, wherein the criterion relates to the number of unique return instructions executed during the first time period, and
initiate, during a second time period, a non-ahead mode of speculative prediction of outcomes of the one or more return instructions based, at least in part, on the criterion.

19. The processor core of claim 18, wherein evaluating the criterion includes tracking, by a Bloom filter, addresses of the one or more return instructions executed during the first time period.

20. The processor core of claim 19, wherein evaluating the criterion further includes comparing a number of entries in the Bloom filter having non-zero values to one or more first threshold values.
